(19) United States
(12) Patent Application Publication
(10) Pub. No.: US 2025/0007609 A1
(43) Pub. Date: Jan. 2, 2025

(54) STEP-INDEX MULTIMODE FIBER, METHOD OF PROCESSING STEP-INDEX MULTIMODE FIBER, AND SYSTEMS AND METHODS FOR HIGHLY DENSE MODE DIVISION MULTIPLEXING INCORPORATING A STEP-INDEX MULTIMODE FIBER

(71) Applicant: CORNING INCORPORATED, CORNING, NY (US)

(72) Inventors: Kevin Wallace Bennett, Hammondsport, NY (US); Xin Chen, Painted Post, NY (US); Rostislav Radiyevich Khrapko, Corning, NY (US); Daniel Aloysius Nolan, Corning, NY (US)

(21) Appl. No.: 18/754,492

(22) Filed: Jun. 26, 2024

Related U.S. Application Data
(60) Provisional application No. 63/524,356, filed on Jun. 30, 2023.

(51) Int. Cl. H04B 10/2581; G02B 6/036; H04J 14/04

(52) U.S. Cl. CPC H04B 10/2581; G02B 6/03633; H04J 14/04

(57) ABSTRACT

Mode Division Multiplexing (MDM) systems using step-index multimode fibers (MMF) are disclosed herein, where the step-index MMF includes at least one glass core and at least one cladding surrounding the core, wherein the step-index MMF comprises a spin profile that was imparted into the step-index MMF during draw by a spinning apparatus according to a spin function, wherein the spin function comprises at least one of sinusoidal function, a Amplitude Modulation (AM) function, a Frequency Modulation (FM) function, or a combination thereof.

### CROSS-REFERENCE TO RELATED APPLICATIONS

This application claims the benefit of priority under 35 U.S.C. § 119 of U.S. Provisional Application Ser. No. 63/524,356 filed on Jun. 30, 2023, the content of which is relied upon and incorporated herein by reference in its entirety.

### BACKGROUND

Optical telecommunication systems rely on various types of multiplexing of optical signals onto a common transmission optical fiber to increase the amount of information that can be transmitted over the transmission optical fiber. The types of multiplexing used include wavelength division multiplexing (WDM), polarization division multiplexing (PDM), frequency division multiplexing (FDM), time division multiplexing (TDM), space division multiplexing (SDM) and mode division multiplexing (MDM).

Mode division multiplexing (MDM) involves combining optical signals (data streams) in different spatial modes supported by a multimode fiber (MMF) or a few-mode fiber (FMF). Conventional MDM systems employ FMFs that have a round core that support two-dimensional mode distributions along both radial and azimuthal directions. However, FMFs suffer from mode coupling among the guided modes of the few-mode fiber. Mode coupling causes issues with inter-modal coupling interference and power loss due to modal attenuation in the few-mode fiber.

Another approach to MDM using MMF also suffers drawbacks due to modal coupling and mode coupling between cores of multicore fiber as spatial modes in a MMF can be subject to channel crosstalk due to mode coupling effects, especially if the MMF is subjected to bending or twisting. MMF fibers also present difficulty at the input and output optics in multiple-input, multiple output (MIMO) applications from the increased complexity of maintaining coherent transmission of multiple modal groups between a plurality of different input cores and output to different target cores of another MMF, fiber bundle, or other receivers. MIMO is best used when the modes involved are better confined in a specified time without inter-modal coupling interference.

Digital signal processing techniques have been developed to deal with channel crosstalk arising from the aforementioned mode coupling. One type of this digital signal processing is commonly referred to as coherent MIMO digital signal processing (DSP). In order to employ MIMO DSP at a high capacity (a large number of channels for a high information density), it has been shown to be beneficial to minimize the temporal digital processing window. To minimize the temporal processing window, it is beneficial to be able to process spatial modes separately but in parallel to one another at the same time.

It has been proposed to utilize different LP modes utilizing MMFs with parabolic refractive index profiles for mode division multiplexing, but such an approach results in large time delay differences between the modes, which makes it difficult to demultiplex the optical signals in the time domain using MIMO.

Accordingly, a need exists for optical multiplexing systems that have the capability to mode multiplex optical signals for transmission over an optical fiber with minimal time delay to facilitate demultiplexing in the presence of mode coupling.

### SUMMARY

The following presents a simplified summary of one or more embodiments of the present disclosure in order to provide a basic understanding of such embodiments. This summary is not an extensive overview of all contemplated embodiments and is intended to neither identify key or critical elements of all embodiments, nor delineate the scope of any or all embodiments.

The disclosure describes a step-index multimode fiber (MMF), a mode division multiplexing system incorporating a step-index MMF, and a method of transmitting an optical signal using a step-index MMF.

According to a first aspect of the disclosure, a step-index multimode fiber (MMF) comprising: at least one core with a central axis, a first relative refractive index 41, a radius r, and a diameter d extending through the central axis; at least one cladding layer surrounding the core, the at least one cladding layer comprising a second relative refractive index 42 smaller than the first relative refractive index 41 of the at least one core; wherein the step-index MMF comprises a spin profile that varies according to a spin function, wherein the spin profile comprises at least one spin period of greater than or equal to 1 meters to less than or equal to 20 meters and at least one spin amplitude greater than zero turns per meter and less than or equal to 10 turns per meter.

A second aspect includes the step-index MMF of the first aspect wherein the spin function is an Amplitude Modulation (AM) spin function or a Frequency Modulation (FM) spin function, or a combination of both.

A third aspect includes the step-index MMF of any of the preceding aspects wherein the spin function is an AM spin function, wherein the AM spin function is defined as: a=[α₀ sin(2πz/Λₘ)]sin(2πz/Λ), wherein α₀ is the spin amplitude and is greater than 0 turns/meter to less than or equal to 10 turns/meter, Λₘ is the spin period in units of meters, wherein Λₘ is in the range of greater than 1 to less than or equal to 10 m, Λ is the mode spacing in meters between propagating modes, wherein Λ is in the range of 1 to 20 m.

A fourth aspect includes the step-index MMF of any of the preceding aspects wherein the spin function is a FM spin function, wherein the FM spin function is defined as:

$$a = {α}_{0} sin \{ 2 π [ {f}_{0} + {f}_{m} sin ( \frac{2 π z}{Λ} ) ] \} ,$$

wherein the spin amplitude is α₀ and is greater than zero and less than or equal to 10 turns/m, f₀ is a center frequency and ranges from greater than or equal to 1 to less than or equal to 10 m⁻¹, fₘ is a modulation frequency that ranges from 1 to 20 m⁻¹, Λ is the spin period and ranges from 1 to 10 m.

A fifth aspect includes the step-index MMF according to any of the preceding aspects wherein the spin function is based on a sinusoidal spin function, wherein the sinusoidal spin function is defined as: a(z)=α₀ cos(ηz) where a₀ is the spin amplitude, z is the length of the fiber in meters and η is an angular frequency of spatial modulations, which is linked to the spin period A in the form of η=2π/Λ.

A sixth aspect includes, the step-index MMF according to any of the preceding aspects wherein the at least one spin period is greater than 3 and less than 10 m and the at least one spin amplitude is greater than 1 and less than or equal to 5 turns per meter.

A seventh aspect includes the step-index MMF according to any of the preceding aspects wherein the radius r is greater than 6 μm and less than 25 μm.

An eighth aspect includes the step-index MMF according to any of the preceding aspects wherein 41-42 is greater than or equal to 0.075% and less than or equal to 2%.

According to a ninth aspect, a mode division multiplexing system (MDM) comprising a step-index multimode optical fiber (MMF) includes: a transmitter system comprising: a linear array of sources configured to emit a plurality of optical signals that form a linear source signal in combination with one another; and a mode multiplexer comprising a first phase plate configured to apply a varying phase to the plurality of optical signals to convert the linear source signal into an annular source signal; and a first optical element configured to focus the annular source signal into a first light cone; an optical link comprising a step-index MMF, wherein the step-index MMF comprises: at least one core with a central axis, a first relative refractive index Δ₁, a radius r, and a diameter d extending through the central axis; at least one cladding layer surrounding the core, the at least one cladding with a second relative refractive index Δ₂, wherein Δ₂ is less than Δ₁ of the at least one core; and a spin profile that varies along a length of the step-index MMF according to a spin function, wherein the spin profile comprises at least one spin period of greater than or equal to 1 meters to less than or equal to 20 meters and at least one spin amplitude greater than zero turns per meter and less than or equal to 10 turns per meter, wherein the step-index MMF is positioned with respect to the optical element such that the first light cone enters the optical fiber at an entrance angle θᵢ associated with a modal group of the step-index MMF such that the plurality of optical signals excite a plurality of spatial modes within the modal group and exit the step-index MMF as a second light cone; and a receiver system comprising: a second optical element configured to convert the second light cone into an annular receiving signal, wherein the step-index MMF reduces temporal spacing between spatial modes within the modal group of the second light cone so that the spatial modes of the modal group arrive simultaneously at the second optical element; a mode demultiplexer comprising a second phase plate configured to apply a varying phase to the annular receiving signal to convert the optical signals exciting each of the plurality of spatial modes to a segment of linear receiving signal; and an array of receiving elements configured to independently receive one of the segments.

A tenth aspect includes the mode division multiplexing system of the ninth aspect wherein the at least one core comprises a diameter that is less than or equal to 25 μm.

An eleventh aspect includes the mode division multiplexing system of any of the ninth through tenth aspects wherein 41-42 is greater than or equal to 0.075% and less than or equal to 2%.

A twelfth aspect includes the mode division multiplexing system of any of the ninth through eleventh aspects wherein the plurality of optical signals are a plurality of coherent optical signals at a single source wavelength λs.

A thirteenth aspect includes the mode division multiplexing system of any of the ninth through twelfth aspects wherein: the transmitter system comprises a plurality of linear arrays of sources, the first phase plate is configured to apply a different varying phase to linear source signals emitted by each of the plurality of linear arrays of sources to convert the linear source signals into a plurality of annular source signals, the first optical element converts each of the plurality of annular source signals into a separate light cone such that each light cone enters the step-index optical fiber at an entrance angle θᵢ associated with a separate modal group of the step-index optical fiber.

A fourteenth aspect includes the mode division multiplexing system of any of the ninth through thirteenth aspects wherein each of the linear arrays of sources comprises a different length, each length being proportional to the modal group number excited by that linear array of sources.

A fifteenth aspect includes the mode division multiplexing system of any of the ninth through fourteenth aspects wherein the optical signals propagate down at least 3 mode groups of the step-index optical fiber.

A sixteenth aspect includes the mode division multiplexing system of any of the ninth through fifteenth aspects wherein the linear array of sources comprises at least four distinct optical signals such that at least four distinct spatial modes of the modal group are excited by within the modal group.

A seventeenth aspect includes the mode division multiplexing system of any of the ninth through sixteenth aspects wherein: the second phase plate is disposed in a plane P1 extending in a direction perpendicular to a waveguide axis of the step-index optical fiber at an exit face thereof, points of peak signal amplitude of the annular receiving signal are contained in a ring having coordinates (x₁, y₁) in the plane P1 after being focused by a conditioning optical element onto the plane P1, and the annularly varying phase ϕ(x₁, y₁) applied by the second phase plate is expressed as:

$$ϕ ( {x}_{1} , {y}_{1} ) = \frac{2 π {x}_{o}}{λ f} [ {x}_{1} {ln ( {x}_{1}^{2} + {x}_{2}^{2} )}^{\frac{1}{2}} - {y}_{1} {tan}^{- 1} ( \frac{{y}_{1}}{{x}_{1}} ) - {x}_{1} ]$$

where f is the focal length of the conditioning optical element and xₒ is a parameter selected to determine the length and the positioning of the linear receiving signal.

According to eighteenth aspect of the disclosure, a method of transmitting optical signals from a transmitter system to a receiver system using a spun step-index multimode optical fiber (MMF), comprising: at the transmitter system, converting a linear source signal output by a linear array of sources into an annular source signal, the linear source signal comprising a plurality of optical signals; focusing the annular source signal as an input cone into a core of a spun step-index multimode optical fiber such that the input cone enters the core at an incidence angle associated with a modal group of the spun step-index optical fiber and each spatial mode of the modal group is occupied by one of the plurality of optical signals; transmitting the optical signals in the spun step-index optical fiber such that optical signals exit the step-index optical fiber as an output cone; and performing at the receiver system mode division demultiplexing of the optical signals by converting each spatial mode into a segment of a linear receiving signal and detecting the linear receiving signal via a linear array of receivers, wherein the spun step-index MMF comprises: at least one core with a central axis, a first relative refractive index Δ₁, a radius r, and a diameter d extending through the central axis; at least one cladding layer surrounding the core, the at least one cladding with a second relative refractive index Δ₂, wherein Δ₂ is less than Δ₁ of the at least one core; and a spin profile that varies along a length of the spun step-index MMF according to a spin function, wherein the spin profile comprises at least one spin period of greater than or equal to 1 meters to less than or equal to 20 meters and at least one spin amplitude greater than zero turns per meter and less than or equal to 10 turns per meter.

A nineteenth aspect includes the method of the nineteenth aspect wherein: the transmitter system comprises a plurality of linear arrays of sources outputting a plurality of linear source signals, the converting comprises applying a different varying phase to each of the plurality of linear source signals to convert the plurality of linear source signals into a plurality of annular source signals, and focusing comprises converting each of the plurality of annular source signals into a separate light cone such that each light cone enters the step-index optical fiber at an entrance angle associated with a separate modal group of the step-index optical fiber.

A twentieth aspect includes the method of any of the eighteenth and nineteenth aspects wherein the optical signals propagate down at least 3 mode groups of the spun step-index multimode optical fiber, wherein the at least 3 mode groups have reduced temporal spacing of spatial modes within each mode group of the optical signals, wherein the optical signals and corresponding modal groups exit as light cones from the step index multimode optical fiber simultaneously.

While multiple aspects are disclosed, still other aspects of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 schematically depicts a mode division multiplexing system, according to one or more embodiments of the present disclosure;

FIGS. 2A and 2B depict cross-sectional views and relative refractive index profile of a step-index optical fiber of the mode division multiplexing system through the line 2-2 in FIG. 1, according to one or more embodiments of the present disclosure;

FIG. 3A schematically depicts a transmitter system of the mode division multiplexing depicted in FIG. 1, according to one or more embodiments of the present disclosure;

FIG. 3B schematically depicts a receiver system of the mode division multiplexing system depicted in FIG. 1, according to one or more embodiments of the present disclosure;

FIG. 4 is a plot of a phase delay introduced by a phase plate of the receiver system depicted in FIG. 3B as a function of an azimuthal angle within an annular receiving signal, according to one or more embodiments of the present disclosure;

FIG. 5 is a plot of position relative to a midpoint of a linear receiving signal that light rays of an annular receiving signal are transmitted to via a phase plate introducing the phase delays depicted in FIG. 4, according to one or more embodiments of the present disclosure;

FIG. 6 depicts an annular optical signal separated into arc segment subgroups for multiplexing in a mode group of a step-index optical fiber, according to one or more embodiments of the present disclosure;

FIG. 7 is a flow diagram of a method of transmitting optical signals from a transmitter system to a receiver system, according to one or more embodiments of the present disclosure;

FIG. 8(a) is a flow diagram of a method of processing a step-index multimode optical fiber, according to one or more embodiments of the present disclosure;

FIG. 8(b) depicts a perspective view of a spinning apparatus, according to one or more embodiments of the present disclosure;

FIG. 9(a) depicts a first part of a first modeled comparison which depicts a graph of DMD data of a fiber with no spin;

FIG. 9(b) depicts a graph of DMD data of a fiber that has been imparted with spin, according to one or more embodiments of the present disclosure;

FIG. 10(a) depicts a first part of a second modeled comparison, which depicts a graph of DMD data of a fiber with no spin; and

FIG. 10(b) depicts a graph of DMD data of a fiber that has been imparted with spin, according to one or more embodiments of the present disclosure.

### DESCRIPTION

The present disclosure relates to systems and methods for mode division multiplexing in a step-index multimode optical fiber by exciting a plurality of spatial modes in one or more angular modal groups of the step-index multimode optical fiber. The mode division multiplexing system and methods described herein comprise utilizing spatially-varying phase delays induced via a suitable optical element or phase plate (e.g., etched glass plate, spatial light modulator, metasurface) to impart linear-to-annular (or vice-versa) geometric transformations to various optical signals. Such geometric transformations can be used to excite various spatial modes in an angular modal group of the step-index optical fiber and allow mode multiplexing within that modal group. For example, a linear array of sources can emit a plurality of optical signals that form a linear source signal in conjunction with one another. This linear source signal (comprising the plurality of individual optical signals) can be incident on a first phase plate, which applies a spatially varying phase to transform each optical signal into an arc segment of an annular source signal, which is focused into the step-index multimode optical fiber as a first light cone that is incident on an entry face of the step-index optical fiber at an angle associated with the angular modal group. As a result, each optical signal may excite a different spatial mode within that modal group, which allows the plurality of optical signals to propagate down the optical fiber simultaneously with minimal time delay therebetween. The optical signals may exit the optical fiber at an exit face thereof as a second light cone, which is collimated and incident on a second phase plate to undergo an annular-to-linear geometric transformation so that the optical signals can be independently received at a receiver array. Minimal time delay between each of the optical signals enables MIMO DSP to occur to mitigate mode coupling.

By using a step-index optical fiber and their associated angular modal groups, the systems and methods described herein facilitate the utilization of multiple (e.g., at least 2, at least 3, at least 4, at least 10, up to 20) modal groups, with each of the modal groups carrying a plurality of optical signals in each spatial mode to facilitate dense mode division multiplexing. Certain existing techniques have relied on other bases for spatial modes. For example, in Huang et al., “Mode Division Multiplexing Using an Orbital Angular Momentum Mode Sorter and MIMO-DSP over a graded-index few-mode optical fiber,” Scientific Reports 5:14931, orbital angular momentum was used as a spatial mode basis in a MMF with a parabolic index profile. OAM modes of the LP₁₁ mode group were utilized as a basis for MDM. This method, however, is not easily scalable to other mode groups and the OAM basis for spatial modes is associated with significant time delays between each spatial mode. The systems and methods described herein do not suffer from such drawbacks because the step index MMF of the present application is spun during drawing to impart specific spin characteristics into the fiber so that during operation the step-index MMF provides tighter pulses of modal groups without inter-modal coupling interference.

More specifically, the step-index MMF described herein is spun during drawing to mitigate manufacturing variations in the optical fiber preform materials that, in turn, cause variations in the alpha parameter of the core of the fiber, variations in the relative refractive index profile of the MMF, and/or variations in the delta % value of at least the core of the optical fiber preform. By spinning the step-index MMF using a spin function according to the embodiments described herein, the step-index MMF has increased bandwidth capacity due to coupling between modes of a modal group but does not have inter modal group coupling, thus when a spun MMF of the embodiments described herein is incorporated into a MDM system, the spun step index MMF allows for arc segments of an annular input signal associated with an angular modal group to be used as a basis for the spatial modes. Existing OAM-based approaches do not utilize such an approach. Furthermore, the geometric transformations described herein enable the angular modal groups to be processed separately from one another (the linear receiving signal from each modal group may be provided to a separate array of linear receivers, enabling independent processing), thereby eliminating issues associated with time delays between different modal groups. Using the systems and methods described herein, a plurality of angular modal groups of the optical fiber can each be excited by a plurality of optical signals, with the optical signals exciting each modal group being received and processed simultaneously and in parallel, facilitating dense MIMO DSP. That is, using the systems and methods described herein, smaller numbers of spatial modes are processed in parallel but at one time, minimizing the digital processing window and enabling a dense MIMO implementation.

As used herein, the term “angle,” when used in describing a particular modal group of a step-index optical fiber, refers to a center angle of a distribution of angles associated with a particular modal group. The angular modal groups described herein are not associated with a single propagation or entry angle, but rather a distribution of angles about a centroid angle.

A parameter described as being “in the range from X to Y” includes the values of X and Y unless otherwise expressly stated in words or by using the “greater than” symbol “>” or the “less than” symbol “<”.

The term “relative refractive index” as used herein is defined as:

$$Δ ( r ) = Δ = [ {n ( r )}^{2} - {n}_{REF}^{2} ) ] / 2 {n ( r )}^{2} \qquad ( 1 )$$

where n(r) is the refractive index at a distance r from the core center. The relative refractive index Δ is defined at 1550 nm unless otherwise specified. In one aspect, the reference index n_{REF} is that for silica glass. In another aspect, n_{REF} is the maximum refractive index of the cladding. As used herein, the relative refractive index is represented by A and its values are given in units of “%”, unless otherwise specified. In cases where the refractive index of a region is less than the reference index n_{REF}, the relative index percent is negative and is referred to as having a depressed region or depressed-index, and the minimum relative refractive index is calculated at the point at which the relative index is most negative unless otherwise specified. In cases where the refractive index of a region is greater than the reference index n_{REF}, the relative index percent is positive, and the region can be said to be raised or to have a positive index.

As used herein, the relative refractive index is represented by Δₙ wherein n=1 for the core and n=2 for the cladding. In the discussion below, n_{REF}=n₂ so that Δ₂=0. The values of Δₙ are given in units of “%,” unless otherwise specified. The Δₙ is also referred to herein as the “relative refractive index profile.”

The term “α-profile” or “alpha profile,” as used herein, refers to a relative refractive index profile, expressed in terms of Δ which is in units of “%,” where r is the radius and which follows the equation,

$$Δ = {Δ}_{1 max} [ 1 - {( \frac{r}{{r}_{1}} )}^{α} ] ,$$

where Δₗₘₐₓ is the maximum relative refractive index, r₁ is the radius of the core, r is in the range rᵢ≤r≤r_{f}, A is as defined above, rᵢ is the initial point of the α-profile, r_{f} is the final point of the α-profile, and a is an exponent which is a real number. For purposes of the present disclosure, a step index profile has an alpha value greater than 7.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

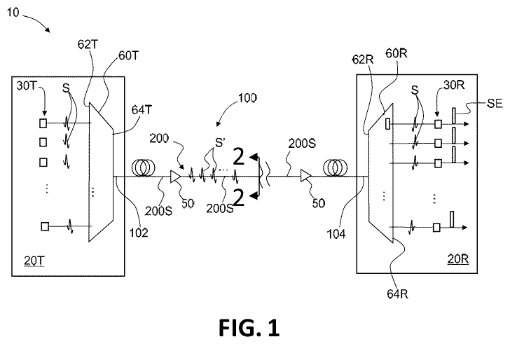

FIG. 1 is a schematic diagram of an example MDM system 10 as disclosed herein. The MDM system 10 includes a transmitter system 20T, a receiver system 20R and an optical fiber link 100 that optically connects the transmitter and receiver systems. The optical fiber link 100 includes at least one section 200S of a step-index optical fiber 200, which is discussed in greater detail below. The optical fiber link 100 has an input end 102 optically connected to the transmitter system 20T and an output end 104 optically connected to the receiver system 20R. In an example, the input and output ends 102 and 104 of the optical fiber link 100 define input and output end faces (entry and exit facts) of the step-index optical fiber 200. In an example, the optical fiber link 100 can include multiple sections 200S of the step-index optical fiber 200, with optical amplifiers 50 operably arranged between adjacent sections 200S. The step-index optical fiber 200 is configured to support multiple mode groups, with each mode group supporting a plurality of spatial modes formed by the transmitter system 20T, as described below. In an example, the step-index optical fiber 200 comprises a spun step-index MMF.

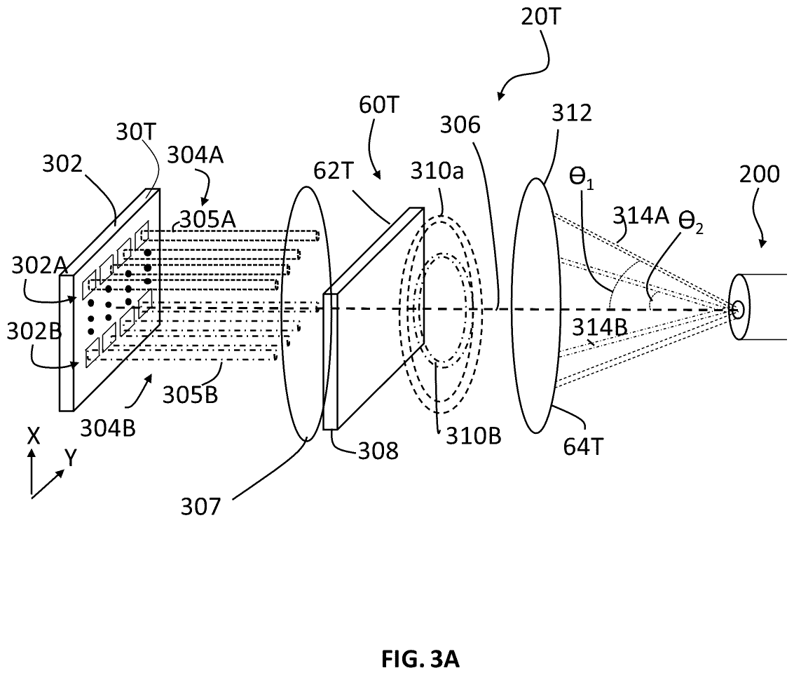

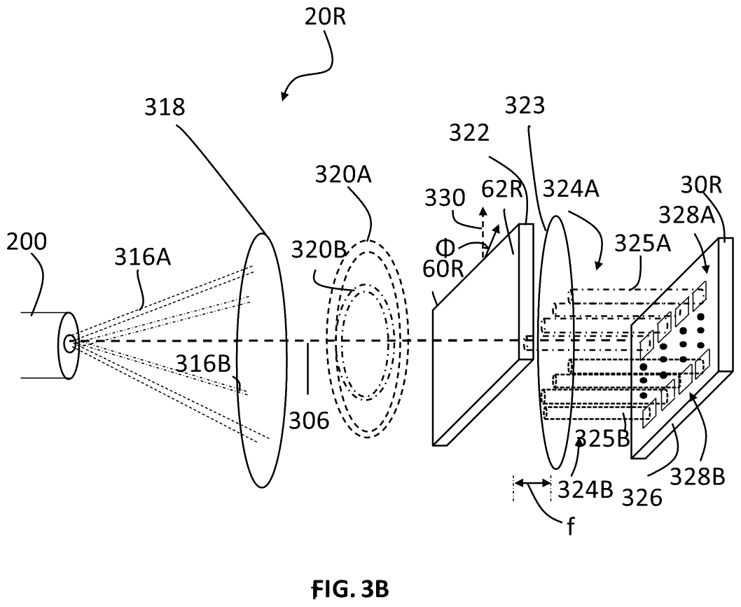

The transmitter system 20T includes transmitters 30T that generate and transmit optical signals S each having the same wavelength λₛ, referred to herein as the “operating wavelength.” The optical signals S are preferably coherent to facilitate use of MIMO DSP. In other embodiments, the optical signals S can have different operating wavelengths. In an example, the optical signals S comprise data signals for different channels. The transmitter system 20T also includes a mode multiplexer 60T having an input end 62T and an output end 64T. As described herein with respect to FIG. 3A, the transmitters 30T can each comprise a linear array of sources configured to emit a plurality of the optical signals S that form a linear source signal in combination with one another. Each one of transmitters 30T can be a single-mode optical fiber emitting an optical signal S (e.g., each optical signal S may travel in a fundamental mode of the single-mode optical fiber). In embodiments, each one of the transmitters 30T can comprise a core of a multi-core optical fiber. In embodiments, each one of the transmitters 30T can include a light emitting element such as a laser, light-emitting diode or the like, configured to the emit an optical signal S. While not depicted, the transmitter system 20T may further include conditioning optical elements configured to guide the optical signals S to the mode multiplexer 60T and/or convert the individual optical signals S emitted by the transmitters 30T into the linear source signals described herein.

The receiver system 20R is configured to receive and process the multimode optical signals S′ that travel over the optical fiber link 100 from the transmitter system 20T to the receiver system. The receiver system 20R has a mode demultiplexer 60R with an input end 62R and an output end 64R. The output end 104 of the optical fiber link 100 is optically connected to the input end 62R of the mode demultiplexer 60R. The mode demultiplexer 60R is configured to receive and separate the multimode optical signals S′ by their spatial modes. The receiver system 20R also includes receivers 30R that are optically connected to the output end 64R of the mode demultiplexer 60R.

In the general operation of the MDM system 10, the transmitters 30T each emit different single mode optical signals S (e.g., different data channels) at the operating wavelength λs. These single mode optical signals S can be referred to as the first single mode optical signals. The first single mode optical signals S travel (e.g., through free-space, through a single mode waveguide) to the input end 62T of the mode multiplexer 60T. As described herein, the mode multiplexer 60T comprises an optical element and lens that converts each of the single mode optical signals S to a multimode optical signal S′ associated with an angular modal group of the step-index optical fiber 200 via a linear-to-annular geometric transformation (each linear source signal is converted to an annular source signal, as described herein). Each single mode optical signal S is focused into the step-index optical fiber 200 to excite a spatial mode of an angular modal group of the step-index optical fiber 200.

The multimode optical signals S′ then travel over the optical fiber link 100 in the different spatial modes of the step-index optical fiber 200 to the receiver system 20R, where they are received at the input end 62R of the mode demultiplexer 60R. The multimode optical signals S′ are then separated by the mode demultiplexer 60R by their individual spatial modes as linear receiving signals via an annular-to-linear geometric transformation, with each receiving signals having segments corresponding to single mode receiving signals S that travel to a corresponding receivers 30R. The receivers 30R can then convert the second single mode optical signals S into respective electrical signals SE. In embodiments, one of the receivers 30R corresponds to one of the transmitters 30T (such that a particular one of the receivers 30R receives a single one of the optical signals S transmitted by a corresponding one of the transmitters 30T).

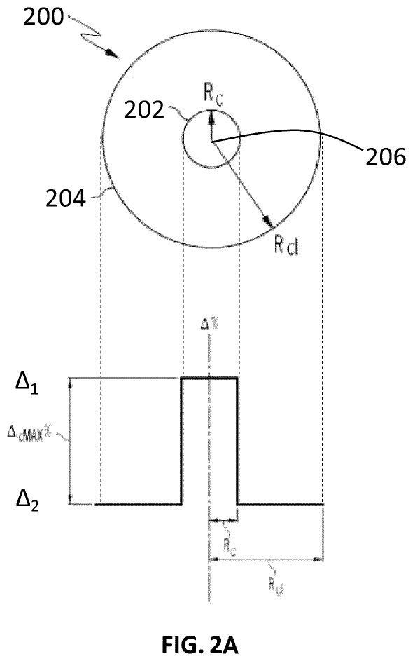

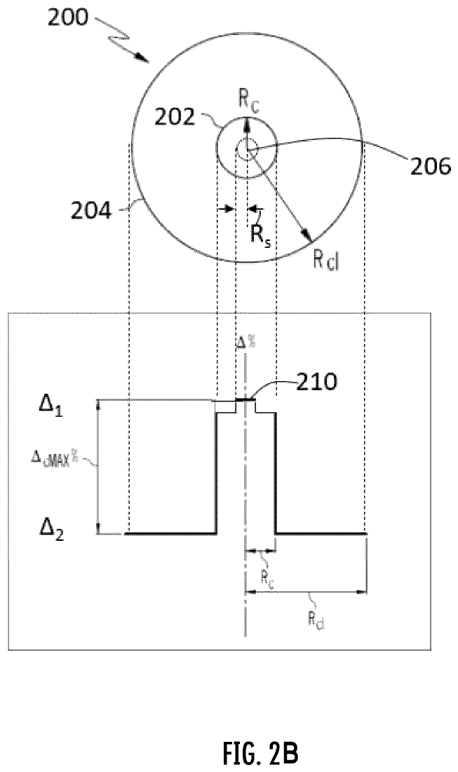

Referring to FIGS. 2A and 2B, a cross section of the glass portion of the step-index optical fiber 200 through the line 2-2, as well as a relative refractive index profile, are schematically depicted according to one or more embodiments described herein. As shown, the step-index optical fiber 200 generally comprises a core 202 surrounded by and in direct contact with a cladding 204. In the embodiments shown and described herein, the core 202 and the cladding 204 generally comprise silica, specifically silica glass. The cross section of the step-index optical fiber 200 may be generally circular-symmetric with respect to the center of the core 202 and the core 202 may have a radius R_{c}. In the embodiments described herein, the radius R_{c} of the core 202 is greater than or equal to about 6 μm and less than or equal to about 25 μm (preferably from 15 μm to 20 μm). The cladding 204 surrounds the core 202 and extends from the radius Re to the radius Rel such that the cladding has a radial thickness T_{cl}=R_{cl}−R. In some embodiments described herein, the radius R_{cl} (i.e., the radius of the glass portion of the step-index optical fiber 200) is about 125 μm. However, it should be understood that the dimensions of the cladding 204 may be adjusted such that the radius R_{cl} may be greater than 125 μm or less than 125 μm.

In the embodiments described herein, the core 202 has a maximum relative refractive index Δ_{cMAX} % relative to the cladding 204 and the cladding 204 has a maximum relative refractive index percent Δ_{cIMAX} % relative to pure silica glass such that Δ_{cMAX} %=Δ₁−Δ₂. In embodiments, Δ_{cMAX} % is greater than or equal to 0.075% and less than or equal to 2%. Limiting Δ_{cMAX} % to less than 2% and limiting Re to less than 25 μm has been found to limit coupling between modal groups to facilitate utilizing a plurality of modal groups for dense MIMO implementation.

In some of the t embodiments shown and described herein, the core 202 comprises pure silica glass (SiO₂) or silica glass with one or more dopants which increases the index of refraction of the glass core relative to pure, undoped silica glass. Suitable dopants for increasing the index of refraction of the core include, without limitation, GeO₂, Al₂O₃, P₂O₅, TiO₂, ZrO₂, Nb₂O₅, Ta₂O₅, and/or combinations thereof. In embodiments, the core 202 can also include chlorine and/or fluorine-doped silica. In the embodiments described herein, the core 202 contains a sufficient amount of dopant such that the maximum relative refractive index Δ_{cMAX} % of the core 202 is from about 0.075% to about 2%, more preferably from about. 0.09% to about 1.5%. Combinations of any of the dopants described in this paragraph can also be used. In one exemplary embodiment, a core comprised a central elevated portion (see below) doped with Germania or chlorine and a remainder that was fluorine doped to exhibit a A of about 0.8% relative to the cladding. It is believed that the fluorine remainder and chlorine central elevated portion of the core facilitated reduced scattering and provided the best attenuation results.

As shown in FIG. 2B, in some embodiments, the optical fiber 200 comprises a double-step relative refractive index profile. In such embodiments, the core 202 comprises a central elevated portion 210 (centered on and symmetric about the fiber axis 206) having a relative refractive index that is greater than that of the remainder of the core 202. The central elevated portion 210 can be the portion of the core 202 having the maximum relative refractive index Δ_{cMAX} % relative to the cladding 204. The central elevated portion 210 can extend from the fiber axis 206 to a step radius Rₛ. A remainder of the core 202 can extend radially from Rₛ to R_{c}. This remaining portion of the core 202 can have a relative refractive index Δ₃ that is less than Δ₁. In embodiments, Δ₁−Δ₃ is greater than or equal to 0.05% and less than or equal to 0.3%, or greater than or equal to 0.1% and less than or equal to 0.3%, or greater than or equal to 0.15% and less than or equal to 0.2%, or greater than or equal 0.16% and less than or equal to 0.25%. In embodiments Rₛ is greater than or equal to 1 μm, greater than or equal to 2 μm or greater than or equal to 3 μm. In embodiments R_{Rc}/Rₛ is less than or equal to 5, less than or equal to 4, or less than or equal to 3, and greater than 2. In some embodiments, 2.5<R_{Rc}/Rₛ<3.5. In some embodiments Rₛ is 2.5 to 3.5 microns, while R_{Rc} is 8 to 10 microns. It has been found that including the central elevated portion 210 can further limit coupling or cross-talk between modal groups. In some embodiments, the central elevated portion can be doped with germania or chlorine or other dopants that raises the index relative to the remainder. For example, the central elevated portion 210 can be doped with chlorine such that Δ₁−Δ₃ is approximately 0.1% (e.g., greater than or equal to 0.95% and less than or equal to 0.105%). Fluorine-doped silica cores can exhibit lower scattering that parabolic index profiles, which usually utilize germania.

For the step-index optical fiber 200, it can be shown that a far-field step pattern corresponds to a mode group spectrum of the waveguide. The step-index optical fiber 200 has M modal groups, and M can be approximated as

$$M = \frac{2 π {n}_{1}}{λ} * {R}_{c} \sqrt{\frac{Δ}{2}} \qquad ( 2 )$$

where n1 is the index of the core, and Δ is calculated according to Equation 1 herein (as represented by the parameter Δ_{cMAX} herein). Each modal group m is associated with meridional rays passing through a fiber axis 206 (a geometric center of the core 202) at a propagation angle θₘ. In the systems and methods described herein, the propagation angle θₘ can be associated with an angle of incidence at which light cones are transmitted into or emitted from the step-index optical fiber 200, and can therefore determine the focal length of various optical elements used to multiplex (MUX) and demultiplex (DEMUX) light cones into and out of the step-index optical fiber 200 to excite spatial modes in a particular modal group m. The propagation angle θₘ can be related to particular modal group number m as follows

$${θ}_{m} = {sin}^{- 1} ( {n}_{1} \sqrt{2 Δ} \frac{m}{M} ) \qquad ( 3 )$$

For the step-index fiber, the propagation angle θₘ increases linearly with modal group number m. For an example where Δ_{cMAX}=1% and R_{c}=9 μm, M=3.7, the angle θₘ associated with the first three modal groups varies with modal group number m as described in the Table 1 below.

TABLE 1

| m | θₘ (degrees) |
|---|---|
| 1 | 3.14 |
| 2 | 6.29 |
| 3 | 9.46 |

Each modal group m can be separated into N subgroups, with each subgroup being composed of a different combination of spatial modes. Each modal group has a mode number computed as m=2μ+v+1, where μ is an azimuthal mode number and v is a radial mode number. According to the WKB approximation, for a particular modal group, values of μ and v that provide values for a propagation constant β that satisfies the relation

$$\frac{λ}{2 π} \geq {n}_{1} , \\ where \qquad ( 4 )$$

$$= \frac{2 π {n}_{1}}{λ} * {( 1 - 2 {Δ ( \frac{m}{M} )}^{2} )}^{\frac{1}{2}} \qquad ( 5 )$$

represent the spatial modes supported by that modal group. Generally a total number of spatial modes supported by the step-index optical fiber can be approximated as M², with M being the maximum value for the modal group number m.

Each spatial mode can also support 2 independent polarization modes. According to Equations 2-4, a first illustrative example step-index fiber with R_{c}=25 μm and Δ=2% provides 20 mode groups with a total of 436 spatial modes (872 including polarization dependency). A second illustrative example step-index fiber with R_{c}=6.2 μm and Δ=0.75% provides 3 modal groups with a total of 10 spatial modes (20 including polarization dependencies). In embodiments described herein, each spatial mode may represent an independent channel over which an optical signal S can be transmitted. These examples demonstrate the dense mode capacity enabled via the systems and methods described herein.

In addition to reducing inter-mode coupling between the modal groups propagating through the step index MMF by increasing the difference between propagation constants of modal groups by limiting the radius of the core and the relative refractive index profiles of the core and cladding of the MMF, the bandwidth capacity of the step-index multimode optical fiber is further enhanced by spinning the fiber during draw.

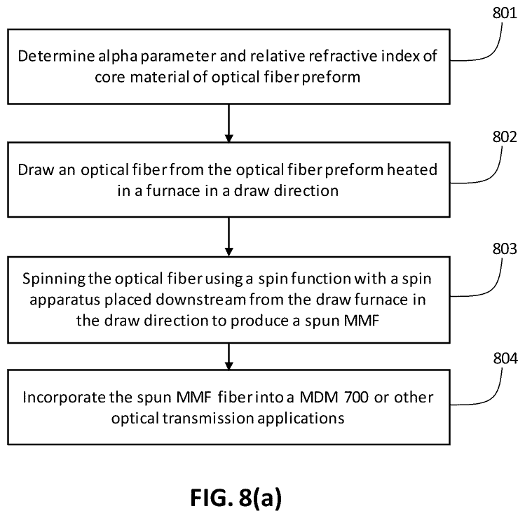

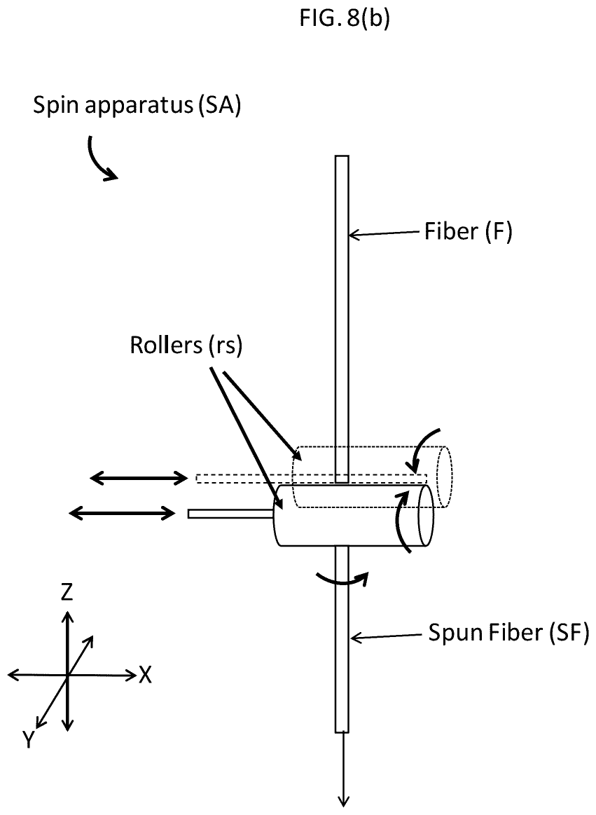

The method of processing a step index multimode optical fiber is summarized in FIG. 8(a) as follows:

In step 801, the alpha and relative refractive index profile of at least one core of the optical fiber preform is determined by conventional measuring techniques. Suitable alpha values of the core of the optical fiber preform should not be particularly limited as long as the core has alpha values comprising typical values for a step-index optical fiber which include core alpha values of greater than or equal to 7. Suitable relative refractive index profiles of the core of the optical fiber preform are not particularly limited. In embodiments, the core has a maximum relative refractive index Δ_{cMAX} % relative to the cladding of greater than or equal to 0.75% to less than or equal to 2%. In embodiments, the core has a maximum relative refractive index Δ_{cMAX} % relative to the cladding of about 1%. In embodiments, perturbations in the core are on the order of or less than 0.5 mm. Upon determining the alpha and the relative refractive index of the core of the optical fiber preform, propagation constants (β) are determined using equation (5) as described hereinabove, which calculates propagation constants β of spatial modes that are supported by a step-index optical fiber with a core comprising a particular relative refractive index. Once the propagation constants β of the supported spatial modes of a particular core of an optical fiber preform are determined, the propagation constants β are then input into equations (7) and (8) as described herein. Based on equations (7) and (8), mode coupling in a step index fiber varies by length of the fiber in the same way as single mode fibers and thus, by spinning a step-index fiber with a spin function during manufacture, as described herein, an improved step index fiber can be produced that comprises a specifically designed spin profile that reduces or eliminates the temporal spacing between the supported spatial modes in a modal group transmitted by the spun step index optical fiber during operation, such as when the fiber is implemented into an MDM 10 or other suitable MDM system or MIMO application.

Continuing to step 802, the optical fiber preform is placed in a heated draw furnace. Thereafter, an optical fiber is drawn from the optical fiber preform along a draw direction, wherein the optical fiber comprises at least one core and at least one cladding layer surrounding the core. The core has a diameter d and radius r relative to a central axis of the core. The central axis is oriented along the draw direction (i.e., along the axial length of the optical fiber).

Referring now to FIGS. 8(a) and 8(b), in step 803, the drawn optical fiber is spun. In particular, the drawn optical fiber F is engaged with a spinning apparatus SA placed downstream from the draw furnace in the draw direction Z (vertical direction in the coordinate axes depicted in the figure), wherein the optical fiber F is spun according to the spin function determined in step 801 using the rollers rs to contact (directly or indirectly) and apply a torque to the drawn optical fiber F in at least one direction orthogonal to the draw direction such as direction X or direction Y according to the coordinate axes depicted in the figures. The spinning performed by the spin apparatus can be unidirectional, bidirectional, or a combination of both. The spinning apparatus applies spin to the drawn optical fiber using techniques such as described in “Fiber Spinning for Reducing Polarization Mode Dispersion in Single Mode Fibers: Theory and Applications” Ming-Jun Li et al. (Proceedings of the SPIE, Volume 5247, p. 87-110 (2003)) which is hereby incorporated by reference in its entirety. Upon exiting the spin apparatus SA, the optical fiber F is a spun step-index fiber SF comprising at least one core with a central axis, a first relative refractive index Δ₁, a radius r, and a diameter d extending through the central axis; at least one cladding layer surrounding the core, the at least one cladding layer comprising a second relative refractive index Δ₂ smaller than the relative refractive index Δ₁ of the at least one core. The spun step-index fiber SF comprises a spin profile that varies along the length of the spun step-index MMF according to the spin function, wherein the spin profile comprises at least one spin period of greater than or equal to 1 meter to less than or equal to 20 meters and at least one spin amplitude greater than zero turns per meter and less than or equal to 10 turns per meter, as described in one or more embodiments herein.

The spin function is selected, as described herein, to increase the modal coupling among the spatial modes of each individual modal group during operation of the spun step-index MMF. The application of spin during drawing of the step-index multimode optical fiber provides for narrow pulses and very narrow temporal pulse propagation of transmitted modal groups and spatial modes within modal groups propagating in the spun step-index MMF during operation. These narrow pulses enable single mode-like propagation through the spun MMF, further enhancing mode division multiplexing. Further, since the inter-mode coupling is decreased in the spun step-index MMF, unwanted interference is reduced. Additionally, attenuation is reduced because the mode coupling between the guided modes to a superposition of cladding modes due to micro bending is also reduced. These features are also important for MIMO transmission, and thus the spun step-index MMFs described herein can be used for higher bandwidth capacity and better MIMO transmission by reducing the temporal spacing between pulses of modal groups to close to or approximately simultaneous arrival.

Referring again to step 803, the spin functions used by the spin apparatus to impart spin into the optical fiber comprise either a sinusoidal spin function, an Amplitude Modulation (AM) spin function, or a Frequency Modulation (FM) spin function, or a combination thereof.

When an AM spin function is used in step 803, the AM spin function is defined as:

$$a = [ {α}_{0} sin ( 2 π z / {Λ}_{m} ) ] sin ( 2 π z / Λ )$$

where z is the length of the fiber in meters and α₀ is the spin amplitude in turns per meter. In embodiments, α₀ can be selected in the range of greater than 0 to less than or equal to 10 turns/meter. In embodiments, α₀ is in the range of 1 to 8 turns per meter, or even in the range of 3 to 6 turns per meter. Λₘ is the spin period in units of meters pertaining to a length of a portion of the fiber with a particular spin amplitude. In embodiments, Λₘ values may be in the range from 1 to 10 m, such as 2 to 8 m, or even 3 to 6 m. In embodiments, Λₘ may be 5 m. Λ is the mode spacing (beat length) between two propagating modes Λ ranges between 1-20 m.

In step 803, when the spin function is an FM spin function, the FM spin function is defined as:

$$a = {α}_{0} sin \{ 2 π [ {f}_{0} + {f}_{m} sin ( \frac{2 π z}{Λ} ) ] \}$$

where z is the length of the fiber in meters and α₀ is the spin amplitude in turns per meter. In embodiments, α₀ can be selected in the range from greater than 0 to 10 turns/meter. In embodiments, α₀ is in the range of 1 to 8 turns per meter, or even in the range of 3 to 6 turns per meter. f₀ is a center frequency in the range of 1 to 10 m⁻¹. fₘ is a modulation frequency in the range of 1 to 20 m⁻¹. Λ is the spin period in units of meters pertaining to a length of a portion of the fiber with a particular spin amplitude. In embodiments, Λ values may be in the range from 1 to 10 m, such as 2 to 8 m, or even 3 to 6 m. In embodiments, Λ may be 5 m. In a particular example of a FM spin function, α₀=3 turns/m, the center frequency f₀=5 m⁻¹, the modulation frequency fₘ=4 m⁻¹, and the spin period Λ=5 m.

When the spin function is based on a sinusoidal spin function, the sinusoidal spin function is defined as:

a(z)=α₀ cos(ηz)

where α₀ is the spin amplitude in turns per meter, z is the length of the fiber, and η is the angular frequency of spatial modulations, which is linked to the spin period in the form of η=2π/Λ. In embodiments, Λ ranges from 1-10 m, or even 3 to 8 m.

In step 804, the spun step-index MMF can be incorporated into a suitable optical transmission application such as a MDM system 10 as described herein.

Referring now to FIG. 3A by way of example, the transmitter system 20T of a MDM system is schematically depicted, according to an example embodiment. In the depicted embodiment, the transmitters 30T are arranged a source array 302. The source array 302 comprises a plurality of linear arrays of sources emitting a plurality of linear source signals. In embodiments, at least one of the linear array of sources emits at least 2 (or at least 4) optical signals such that at least 2, or at least 4, distinct spatial modes of a modal group of the step-index optical fiber 200, such as a spun step-index MMF as described herein, are excited. In embodiments, the source array 302 emits a number of linear source signals that corresponds to a number of modal groups of the step-index optical fiber 200 that are excited by the source array 302. Each of the plurality of linear source signals can be disposed in a different position relative to an optical axis 306 of the mode division multiplexing system 10 in a first plane (the X-Y plane depicted in FIG. 3A). In the depicted embodiment, a first linear array of sources 302A emits a first linear source signal 304A and a second linear array of sources 302B emits a second linear source signal 304B. The first and second linear arrays of sources 302A and 302B can each comprise a plurality of independent optical signal sources such as single mode optical fibers or suitable light sources (e.g., light emitting diodes, laser diodes, other suitable coherent light source).

As shown, the first linear array of sources 302A emits a first plurality of optical signals 305A and the second linear array of sources 302A emits a second plurality of optical signals 305B. In embodiments, the first and second linear arrays of sources 302A and 302B can comprise the same or different numbers of independent optical signal sources. In embodiments, each of the first and second pluralities of optical signals 305A and 305B contains a number of optical signals associated with a number of spatial modes in a particular modal group of the step-index optical fiber 200. In embodiments, the first and second linear arrays of sources 302A and 302B can comprise different lengths in a plane (the X-Y plane in FIG. 3) extending perpendicular to the optical axis 306, with the lengths being proportional to the modal group number excited by the linear source signal emitted thereby. As described herein, the linear-to-annular geometric transformation conducted via the transmitter system 20T enables different lengths of linear source signals at a different position in the plane to be transformed into annular source signals of different radii. Accordingly, in embodiments, each of the first and second linear arrays of sources 302A and 302B have the same linear density of source signals (e.g., in terms of number of light sources per mm) but differ in number of optical signal sources to exhibit such different lengths. While not depicted in FIG. 3A, the transmitter system 20T can include optical elements (e.g., lens arrays or the like) that modify the shape of the optical signals to form the independent optical signals into the linear source signals (e.g., a cylindrical lens array can be used to form the first and second linear source signals 304A and 304B)

The mode multiplexer 60T comprises a first phase plate 308 disposed in in a plane parallel to the X-Y plane. A conditioning optical element 307 may focus light rays in the linear source signals to particular locations at the input end 62T to effectuate a linear-to-annular geometric transformation of the linear source signals. The first phase plate 308 is configured to apply varying phases to each of the linear source signals emitted by the source array 302 to convert each of the plurality of linear source signals into a separate annular source signal. The varying phases applied by the first phase plate 308 can perform a different linear-to-annular geometric transformation on each the plurality of linear source signals to transform the linear source signals into a plurality of concentric annular source signals. In embodiments, the first phase plate 308 can be implemented as a metamaterial (or metasurface), a spatial light modulator, a computer-generated hologram, an integrated waveguide device, or other suitable optical element capable of exhibiting the annular-to-linear geometric transformations described herein. The first phase plate 308 may comprise an array of areas, with each array configured to apply a discrete phase shift to a portion of the first and second linear source signals 304A and 304B associated with one of the individual optical signals described herein. Each optical signal in the first plurality of optical signals 305A can be geometrically transformed into an arc-shaped segment (or plurality of segments) of a first annular source signal 310A and each optical signal in the second plurality of optical signals 305B can be transformed into an arc-shaped segment of a second annular source signal 310B. The arc-shaped segments can correspond to a spatial mode associated with the modal group that the annular source signal is configured to excite in the step-index optical fiber 200. Precise values of the phases induced in each region of the first phase plate 308 can be provided by an inverse of the phase described herein with respect to the receiver system 30R depicted in FIG. 3B. The first and second annular source signals 310A and 310B can comprise different radii from the optical axis 306 depending on at least one of: (a) the length of the linear source array (i.e., the first and second linear source arrays 305A and 305B) used to generate the optical signals contained therein; and (b) the positioning of that linear source array in the X-Y plane.

Referring still to FIG. 3A, the transmitter system 20T further comprises a first optical element 312 (e.g., convex lens) configured to focus the annular source signals generated from the plurality of linear source signals into a plurality of concentric input cones. The first optical element can comprise a focal length that is determined based on the radii of the annular source signals generated by the first phase plate 308 so that the each of the plurality of input cones enter the core 202 (see FIG. 2A) at an entrance angle corresponding to a propagation angle θₘ associated with a distinct modal group m of the step-index optical fiber 200 in accordance with Equations 2-4 herein. While a single optical element is depicted, it should be appreciated that any suitable number of optical elements may be used (e.g., an array of optical elements can apply a varying optical power to each of the annular source signals). In the depicted example, the first annular source signal 310A is focused into the step-index optical fiber 200 so that light rays associated therewith form a first input cone 314A and enters the fiber when propagating at a first angle θ₁ associated with a first mode group of the step-index optical fiber 200 and the second annular source signal 310B is focused into a second input cone 314B so that light rays associated therewith enter the fiber when propagating at a second angle θ₂ associated with a second mode group of the step-index optical fiber 200. A particular positioning of an optical signal in the X-Y plane therefore determines which particular modal group of the step-index optical fiber 200 that that optical signal excites, and, more particularly, which particular spatial mode within that modal group. A particular positioning of an optical signal (x,y) in the depicted X-Y plane therefore determines which signals that that optical signal will be combined with in exciting different spatial modes in a particular modal group. Such an approach allows for multiplexing to be conducted separately for each modal group, allowing minimal time delays for MIMO DSP while also facilitating dense multiplexing through utilization of multiple modal groups for different groups of optical signals.

With reference to FIG. 3B, operation of the receiver system 20R is described in greater detail, according to an example embodiment of the present disclosure. As shown, after propagating in the step-index optical fiber 200, light rays exciting each mode group exit the step-index optical fiber 200 in a plurality of output cones with different radii and reduced temporal spacing due to the step-index optical fiber being spun during drawing. In the depicted example, light exciting the first mode group entering the step-index optical fiber 200 in the first input cone 314A exit the step-index optical fiber 200 in a first output cone 316A and light exciting the second mode group entering the step-index optical fiber exit the step-index optical fiber 200 in a second output cone 316B. The output cones exit the optical fiber propagating at the propagation angles θₘ associated with the modal groups described herein.

The receiver system 20R comprises a second optical element 318 configured to convert the plurality of output cones into a plurality of concentric annular receiving signals, with each annular receiving signal comprising a distinct radius depending on the propagation angle θₘ. The second optical element 318 can comprise a collimating lens and the exit face of the step-index optical fiber 200 can be disposed in a focal plane of the second optical element 318 to generate the annular receiving signals. In the example shown, the first output cone 316A is converted to a first annular receiving signal 320A having a first radius and the second output cone 316B is converted to a second annular receiving signal 320B having a second radius that is less than the first radius.

The receiver system 20R further comprises a mode demultiplexer 60R comprising a second phase plate 322 configured to apply varying phases to each annular receiving signal to convert each annular receiving signal to a linear receiving signal such that the linear receiving signals are separated from one another in a receiving plane (of a receiver array 326). A conditioning optical element 323 may have a focal length f and be configured to focus light rays contained in the annular receiving signals after transmission through the second phase plate 323 to form the annular receiving signals. The second phase plate 322 can be constructed similarly to the first phase plate 308 described herein with respect to the transmitter system 20T (e.g., comprising discrete regions configured to apply different phase shifts to the annular receiving signals). In the depicted example, the second phase plate 322 can apply a first varying phase to the first annular receiving signal 320A (the phase can vary as a function of azimuthal angle ϕ around the optical axis 306) to convert the first annular receiving signal 320A into a first linear receiving signal 324A. The second phase plate 322 can also apply a second varying phase to the second annular receiving signal 320B to convert the second annular receiving signal 320B into a second linear receiving signal 324B.

In embodiments, if points of peak signal amplitude of the first and second annular receiving signals 320A and 320B are contained in a ring having coordinates (x₁, y₁) at a planar surface of the second phase plate 322 (corresponding to the input end 62R) after being focused by the conditioning optical element 323, a varying phase ϕ(x₁, y₁) applied to the annular receiving signals can be expressed as

$$ϕ ( {x}_{1} , {y}_{1} ) = \frac{2 π {x}_{o}}{λ f} [ {x}_{1} {ln ( {x}_{1}^{2} + {x}_{2}^{2} )}^{\frac{1}{2}} - {y}_{1} {tan}^{- 1} ( \frac{{y}_{1}}{{x}_{1}} ) - {x}_{1} ] \qquad ( 6 )$$

where f is the focal length of the conditioning optical element 323 and xₒ is a parameter selected to determine the length and the positioning of the linear receiving signal in the receiving plane. The term

$${( {x}_{1}^{2} + {x}_{2}^{2} )}^{\frac{1}{2}}$$

can be normalized to a chosen value Rₒ, where Rₒ is a normalization radius (e.g., R₀=10 microns), then the annularly varying phase ϕ(x₁, y₁) applied to the annular receiving signal is expressed as

$$ϕ ( {x}_{1} , {y}_{1} ) = \frac{2 π {x}_{o}}{λ f} [ {x}_{1} ln ( \frac{{( {x}_{1}^{2} + {x}_{2}^{2} )}^{\frac{1}{2}}}{{R}_{o}} ) - {y}_{1} {tan}^{- 1} ( \frac{{y}_{1}}{{x}_{1}} ) - {x}_{1} ]$$

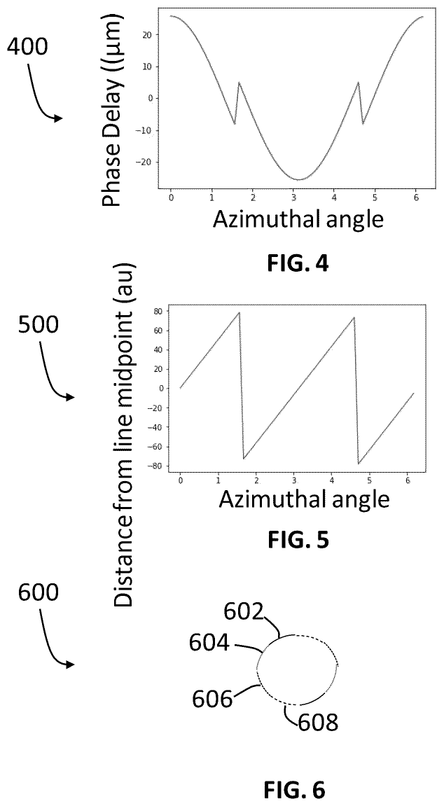

This coordinate transformation is used as part of a ring-to-point geometric transformation in J. Cederquist and A. Tai, “Computer-Generated Holograms for Geometric Transformations, Applied Optics,” 23, #18, 3099-3104, hereby incorporated by reference in its entirety. This reference does not appreciate the potential of utilizing segments of linear signals to excite different spatial modes associated with a step-index optical fiber, as described in the present disclosure. A plot 400 of a magnitude of the phase ϕ(x₁, y₁) calculated for an annular receiving signal with a radius of 500 μm and a focal length f=1 cm for the conditioning optical element 323 is shown in the FIG. 4. The calculated values (expressed in micron delays) can be converted to fractions of a wavelength for constructing a spatial light modulator for use as the second phase plate 322.

Referring back to FIG. 3B, in embodiments, the second phase plate 322 may be constructed with discrete regions of constant phase calculated over intervals for the values x₁ and y₁. As a result, each annular receiving signal 320A and 320B, which is constructed of a plurality of optical signals that each excited a particular modal group of the step-index optical fiber 200, may be converted to a linear receiving signal that is projected to a line in the receiving plane having a different length (e.g., proportional to the number of distinct optical signals contained therein) and positioning in the receiving plane. The first annular receiving signal 320A is converted to a first linear receiving signal 324A comprising a plurality of optical signals 325A (with each of the optical signals 325A making up a segment of the first linear receiving signal 324A). The second annular receiving signal 320B is converted to a second linear receiving signal 324B comprising a plurality of optical signals 325B (with each of the optical signals 325B making up a segment of the second linear receiving signal 324B).

The receiver array 326 generally comprises an array of receivers configured to individually receive each of the optical signals emitted by the source array 302 (see FIG. 3A). The receivers may convert the optical signals to digital signals for DSP. The receiver array 326 can comprise a plurality of linear arrays of receivers, with each linear array of receivers being configured to receive one the linear receiving signals generated via the second phase plate 322. As shown, the receiver array 326 comprises a first linear array of receivers 328A comprising a receiver for each of the plurality of optical signals 325A contained in the first linear receiving signal 324A. The receiver array 326 further comprises a second linear array of receivers 328B comprising a receiver for each of the plurality of optical signals 325B contained in the first linear receiving signal 324B. The first and second linear arrays of receivers 328A and 328B can comprise varying lengths in a plane perpendicular to the optical axis 306 based on the lengths of the linear receiving signals that they are receiving. There may be a 1:1 correspondence between the receivers in the receiver array 326 and the sources in the source array 302, so that each optical signal emitted by source of the source array 302 is received by a corresponding receiver in the receiving array. The annular-to-linear phase transformation in accordance with Equation 6 is beneficial in that optical signals exciting different mode groups of the step-index optical fiber 200 are offset from one another and can be processed separately from one another. The minimal delay between spatial modes in each modal group enables demultiplexing via MIMO, while still utilizing multiple modal groups to provide dense mode division multiplexing.

Referring to FIGS. 3A-6, operation of the MDM system 10 can be generally described as follows. The source array 302 emits a plurality of linear source signals 304A, 304B, with each of the linear source signals comprising a plurality of optical signals 305A, 305B. The plurality of optical signals 305A, 305B can comprise a plurality of coherent optical signals at an operating wavelength λₛ (e.g., 1550 mm). The plurality of linear source signals 304A, 304B comprise a length and position that the determines the particular portions of the first phase plate 308 that light rays thereof are focused onto, the particular portions imparting varying phases to the light rays to as to impart independent linear-to-annular geometric transformations (using an inverse of Equation 6) on each of the plurality of linear source signals 304A, 304B and generate a plurality of annular source signals 310A, 310B. In embodiments, the first phase plate 308 is a spatial light modulator or a metasurface. Polarization-dependent and polarization-independent versions of the first phase plate 308 can be used depending on whether polarization modes associated with each spatial mode are utilized. A first optical element 312 focuses each of the plurality of annular source signals 310A, 310B so that light rays thereof are incident on the core 202 of the step-index optical fiber 200 at one of the propagation angles θₘ described herein associated with a modal group of the step-index optical fiber 200.

After propagation through the step-index optical fiber 200, a plurality of output cones 316A, 316B are emitted at the propagation angles θₘ and subsequently collimated by the second optical element 318 into the plurality of annular receiving signals 320A, 320B.

Due to spinning the step-index optical fiber 200 during draw, as described herein, light cones 316A, 316B emitted at the end face of the step-index optical fiber 200 are separated into annular rings and each annular ring comprises a different modal group with increased intra modal group coupling. As a result, within each different modal group, modes arrive with a very narrow temporal pulse due to modal coupling among the spatial modes of each modal group created due to the spinning during drawing.

Further, by providing a step-index optical fiber 200 which is spun such that the modal groups are the propagating modes of the fiber, bandwidth capacity of the optical fiber can be increased without increased inter modal group coupling.

Mode coupling in optical fibers is analyzed in the literature including in C. Vassallo: Optical Waveguide Concepts (Optical Wave Sciences and Technology), Elsevier Science (Oct. 31, 1991). Specifically, the mode coupling coefficient between two modes (1,2) is given by:

$$B ( 1 , 2 ) = w * n \hat{} 2 / ( 4 * β1 - β2 ) \int [ ( γ n \hat{} 2 / γ z ) ψ1 * ψ2 ] \qquad ( 7 )$$

And the power transfer with length is then:

$$dC 2 / dz = \int [ B ( 1 , 2 ) exp [ i * ( Υ1 - Υ2 ) dZ * C 1 ( Z ) \qquad ( 8 )$$

Equation 8 shows that that the power transfer with length requires a match in frequency of the modes. Such a frequency with length can be achieved with a perturbation changing with length matching the difference in frequency between the two modes of interest (i.e. two or more modes within a modal group). By spinning the fiber during draw using a spin function as described herein, such a frequency can be realized in the spun step-index MMF. This, in turn, reduces polarization mode dispersion of the modes within a modal group. That is, the spin function used to spin the fiber can be determined based on the frequencies of the different modes of interest. Hence, equations (7) and (8) can be used to determine the frequencies of the different modes which, in turn, can be used to determine the appropriate spin function to apply to the fiber to facilitate narrow pulses and very narrow temporal pulse propagation of transmitted modal groups and spatial modes within modal groups propagating in the spun step-index MMF during operation. The frequency changes with length are on the order of meters to match the polarization mode propagation length differences. For the group modes (i.e. modal groups) in a multimode fiber, the intra mode frequencies with length are expected to be similar to that of the polarization modes in single mode fiber (i.e., meters). These frequencies with length are expected to be less than a millimeter for inter mode coupling. This is estimated using the inter mode propagation constants of an OM3 fiber, for example.

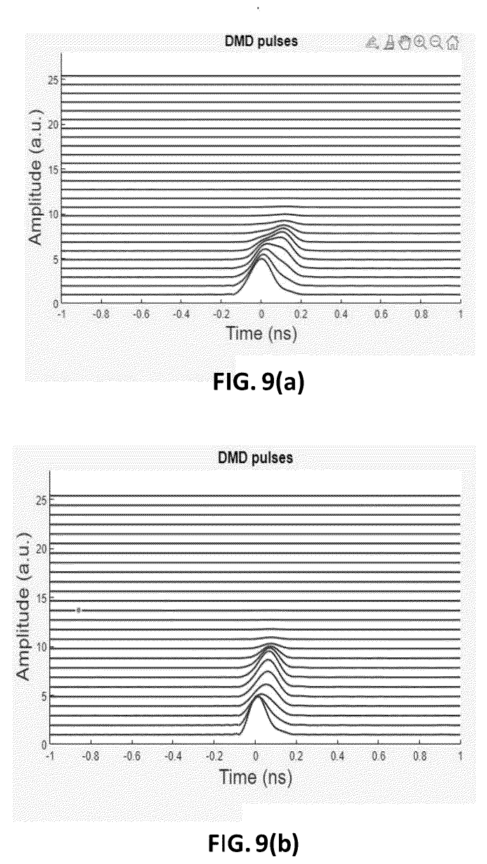

FIGS. 9(a) and 9(b) show a first modeled comparison between spinning a fiber during draw with a specific spin period (FIG. 9(b)) as discussed herein, and a fiber with no-spin during draw (FIG. 9(a)). The comparative example uses differential mode delay (DMD) data taken on an 18 micron diameter, 1% core delta fiber, excited with 850 nm wavelength light.

As shown in FIG. 9(a), the DMD data is shown with amplitude (arbitrary units) of the pulse on the vertical axis of the graph, and time (ns) is the horizontal axis of the graph. As shown, there is significant pulse spreading within a modal group pulse in the fiber with no-spin during draw. In particular, peaks of the modes of the modal group shift gradually in the horizontal direction beyond time=0.2 ns and thus do not arrive simultaneously, increasing the temporal windows of the pulse which, in turn, increases the amount of processing that is required in MIMO and MDM applications.

However, in FIG. 9(b), the DMD data shows the fiber spun with a 10 m spin period according to the spun step-index MMFs described herein. As depicted in FIG. 9(b), the pulses of the modal group are aligned where the mode arrival peaks are centered over each other and thus the modal group arrives nearly simultaneously in time (i.e., with decreased temporal spacing relative to the no-spin fiber of FIG. 9(a)).

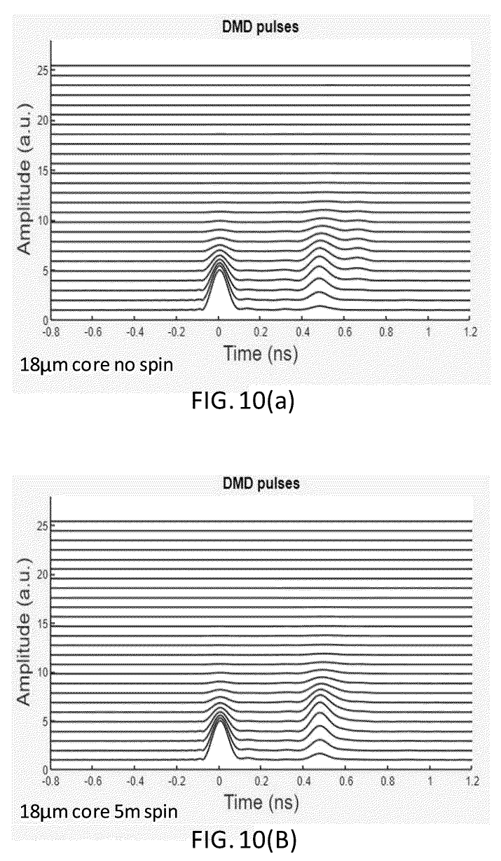

Referring to FIGS. 10(a) and 10(b), a second modeled comparison between spinning a fiber during draw with a specific spin period (FIG. 10(b)) as discussed herein, and a fiber with no-spin during draw (FIG. 10(a)) is illustrated. This comparative example uses differential mode delay (DMD) data taken using 18 μm core diameter, 1% core delta fiber, excited with 1550 nm wavelength light.

As shown in FIG. 10(a), the DMD data is shown with amplitude (arbitrary units) of the pulse on the vertical axis of the graph, and time (ns) is the horizontal axis of the graph. As shown, there is significant pulse spreading within a modal group pulse in the fiber with no-spin during draw. In particular, peaks of the modes of the modal group between 0.4 and 0.6 ns shift gradually in the horizontal direction beyond time=0.4 ns with some modes having an additional smaller peak after 0.6 ns. The data demonstrates that modes of the modal group do not arrive simultaneously, increasing the temporal windows of the pulse which, in turn, increases the amount of processing that is required in MIMO and MDM applications.

However, in FIG. 10(b), the DMD data shows the fiber spun with a 5 m spin period according to the spun step-index MMFs described herein. In FIG. 10(b), the pulses of the modal group are aligned and the mode arrival peaks are centered over each other between 0.4 and 0.6 ns without an additional smaller peak. Thus, the modal group arrives nearly simultaneously in time (i.e., with decreased temporal spacing relative to the no-spin fiber of FIG. 10(a)).

Using a spun step-index MMF as described herein, incorporated into the MDM system 10 as described herein, allows for MDM with increased bandwidth capacity and better applicability to MIMO application by reducing the temporal spacing of modal groups and thus allowing for decreased DSP processing time.

Continuing with the operation of the MDM 10, the light rays emitted from the spun step index optical fiber 200 corresponding to the plurality of annular receiving signals 320A, 320B are transmitted into the second phase plate 322, which may apply a varying phase according to Equation 6. The varying phase may vary as a function of an azimuthal angle about the optical axis 306 as shown in FIG. 4. As shown in FIG. 4, the phase is symmetrical about an azimuthal angle (relative to an axis 330 at the centers of the plurality of linear receiving signals 324A, 324B) of approximately 180°, indicating, for example, that the same phase is applied at a first azimuthal angle (180°−ϕ) and a second azimuthal angle (180°+ϕ). As a result, modal groups of the step-index optical fiber are converted to linear strips (represented by the plurality of linear receiving signals 324A, 324B) having varying lengths and positions relative to the optical axis 306. Light rays in the plurality of linear source signals 304A, 304B and plurality of linear receiving signals 324A, 324B generally propagate parallel to one another (e.g., parallel to the optical axis 306).

As demonstrated by FIG. 5, when using the geometric transformation represented by Equation 6, specific azimuthal positions within the plurality of annular receiving signals 320A, 320B transform to linear positions within each of the plurality of linear receiving signals 324A, 324B. FIG. 5 shows a plot 500 of linear positioning of light rays within one of the plurality of linear receiving signals 324A, 324B as a function of the azimuthal angle ϕ for that particular light ray. The azimuthal angle ϕ represents the positioning of that light ray on a ring of peak amplitude of one of the plurality of annular receiving signals 320A, 320B relative to the axis 330. The spatial transmission is double valued in that two-positions in each of the plurality of annular receiving signals 320A, 320B correspond to a single position in a linear receiving signal. FIG. 6 demonstrates how arc-segments of a ring can form segments of one of the linear receiving signals. As shown, half of an annular receiving signal can be subdivided into a first arc segment 602, a second arc segment 604, a third arc segment 606, and a fourth arc segment 608. According to the geometric transformation of represented in FIGS. 5-6, each of the first, second, third, and fourth arc segments 602, 604, 606, and 608 can be transformed into a separate linear segment of one of the plurality of linear receiving signals 624A, 624B. While four arc segments are depicted in FIG. 6, it can be understood that optical signals exciting modal groups of the step-index optical fiber 200 can be separated into any suitable number of arc segments (e.g., corresponding to a number of optical signals that have been multiplexed into that mode group). In embodiments, each arc segment can correspond to a range of azimuthal angles Δϕ in the plurality of annular receiving signals 320A, 320B. Each modal group of the step-index optical fiber 200 may have an azimuthal resolution Δϕₘᵢₙ that varies depending on the number of spatial modes N within each modal group m.

The azimuthal resolution Δϕₘᵢₙ can determine a maximum number of optical signals that are multiplexed in a particular modal group of the step-index optical fiber 200. This can in turn determine the arrangement of the source array 302 and the receiver array 326. For example, the first linear array of sources 302A can include a number of sources corresponding to a maximum number of distinct spatial modes associated with the modal group excited by the angle θ₁ after the first linear source signal 304A is transformed into the first annular source signal 310A via the first phase plate 308. The first annular source signal 310A can be divided into a number of arc segments as described herein with respect to FIG. 6 so that each arc segment excites a particular spatial mode in the modal group associated with the angle θ₁. Components of the transmitter system 20T are configured such that linear segments of the first linear source signal 304 made up of a distinct one of the plurality of optical signals 305A correspond to such arc segments and so each distinct optical signal excites an associated spatial mode within the modal group associated with the angle θ₁. After emission from the step-index optical fiber 200, each arc segment can be converted to a linear segment of the first linear receiving signal 324A and be received in a separate receiver of the receiver array 326 to facilitate processing each mode group separately and each optical signal within each mode group with minimal time delay to facilitate MIMO.

Since single mode optical fibers effectively output light into a well-defined optical cone, the geometric transformations described herein can also be applied to embodiments including multi-core optical fibers. One can connect each core of a multi-core optical fiber (not depicted) to, for example, a targeted core of another multi-core optical fiber, a source on the source array 302, or a receiver on the receiver array 326. For example, a phase plate having an array of circular phase transformations can be placed to direct a targeted core of a multi-core optical to a targeted single core optical fiber. Since the cores are displaced from the center of the multi-core optical fiber, it is necessary to transfer light in the plane perpendicular to the entry/exit face of the multi-core optical fiber. The phase transformation conducted on the signals in each core can therefore be slightly different to account for this need of light transfer. The transformation provided to each core can be expressed as

$$ϕ ( x , y ) = \frac{α 2 π {r}_{n}}{λ f} \qquad ( 9 )$$

where (x,y) represents positioning of a light ray in a light one on an entry surface of a phase plate, rₙ is the average radius of the circular signals associated with the cones of the optical signals emitted by the multi-core optical fiber when the cones are incident on the phase plate, f is the focal length of lens focusing light rays onto the phase plate, and α is an adjustable parameter that shifts the positioning of the transformed light. Using Equation 9 above, different optical signals can be coupled from single mode fibers (e.g., in a fiber bundle) to individual cores of multi-core optical fiber (and vice-vera). Equation 9 transform output cones into positional points for coupling into additional elements (e.g., other single mode fibers, cores of a multi-core fiber, etc.).

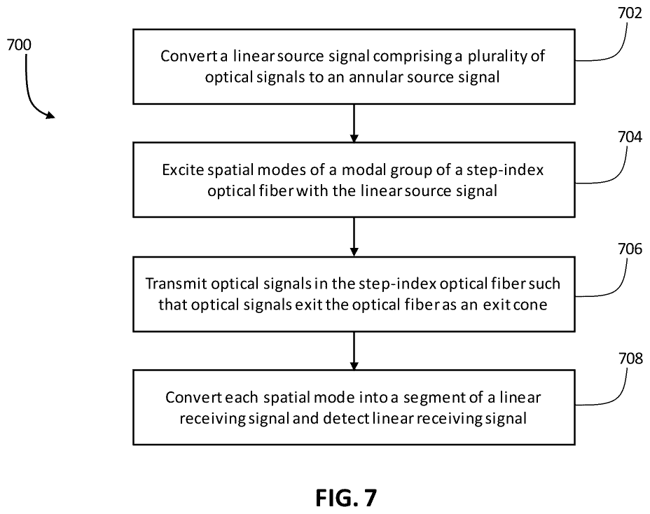

Referring now to FIG. 7, a flow diagram of a method 700 of transmitting optical signals from a transmitter system to a receiver system is shown, according to an example embodiment. The method 700 may be performed by the MDM system 10 described herein with respect to FIGS. 1-6 and incorporating the spun step-index MMF described herein. Accordingly, various components of the MDM system 10 will be referenced to aid in the description of the method 700, with the understanding that the MDM system 10 can be performed by other optical transmission systems. At block 702, at the transmitter system 20T, a linear source signal comprising a plurality of optical signals output by a linear array of sources is converted into an annular source signal. For example, the linear array of sources 302A can include a plurality of signal sources (e.g., single mode optical fibers, light sources) that emit the plurality of optical signals 305A that form the first linear source signal 304A. The first linear source signal 304A can be transmitted through the conditioning optical element 307 and focused onto the first phase plate 308, which applies a spatial varying phase to the first linear source signal 304A to convert the first linear source signal 304A to the first annular source signal 310A. In embodiments, each of the plurality of optical signals 305A is contained in half of the first annular source signal 310A due to the duality of the phase introduced by the first phase plate 308, as described herein with respect to FIGS. 4-6.

At block 704, the first annular source signal 310A is focused by first optical element 312 to form the first input cone 314A that enters the core 202 of the step-index optical fiber 200 at an incidence angle θ₁ associated with a first modal group of the step-index optical fiber 200. Each spatial mode of the modal group can be occupied by one of the plurality of optical signals 305A contained in the first annular source signal 310A. At block 706, the plurality of optical signals 305A are transmitted in the step-index optical fiber 200 such that optical signals exit the step-index optical fiber as the first output cone 316A. At block 706, mode division demultiplexing of the source signals is performed at the receiver system 20R by converting each spatial mode into a linear segment the first linear receiving signal 324A and detecting the first linear receiving signal 324A via the linear array of receivers 328A of the receiver array 326. As described herein, the first output cone 316 is collimated by the second optical element 318 and converted to the first annular receiving signal 320A. Each of the plurality of optical signals 305A may be substantially contained in an arc segment associated with a range of azimuthal angles ϕ. In embodiments, each of the arc segments is contained in a half of the first annular receiving signal 320A. The conditioning optical element 323 focuses the first annular receiving signal 320A onto the second phase plate 322, which may apply a spatially varying phase in accordance with Equation 6 herein to convert the first annular receiving signal 320A to the first linear receiving signal 324A. The first linear receiving signal 324A comprises a plurality of transmitted optical signals 325A that corresponds to the plurality of optical signals 305A contained in the first linear source signal 304A. The linear array of receivers 328A may include a receiver for each of the plurality of optical signals 325A contained in the first linear receiving signal 324A. Such a configuration is beneficial in that there is an array of receiving elements for each group of optical signals that excite a particular modal group of the step-index optical fiber.

As described herein, a benefit of the configuration of the MDM system 10 described herein is that multiple mode groups of the step-index optical fiber that was spun during draw can be excited to facilitate multiplexing a relatively high number of distinct channels within the step-index optical fiber. In embodiments, optical signals may propagate down at least 3 modal groups (or even at least 10 modal groups, or even at least 20 modal groups) such that at least 10 distinct spatial modes (a combined number of spatial modes for the various modal groups excited) are utilized. In an example with 3 modal groups, 10 distinct spatial modes (or 20 using the two polarization modes supported by each spatial mode) may be excited by the optical signals emitted from the source array 302 (three distinct linear source signals may be emitted in this case, with each linear source signal exciting a distinct mode group). In an example with 20 mode groups, 436 modal groups (or 872 using the two polarization modes supported by each spatial mode) using may be excited by optical signals emitted from the source array 302 (20 distinct linear source signals may be emitted in this case, with each linear source signal exciting a distinct mode group). These examples demonstrate the relatively high capacity of the methods described herein.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A step-index multimode fiber (MMF) comprising:
at least one core with a central axis, a first relative refractive index Δ₁, a radius r, and a diameter d extending through the central axis;
at least one cladding layer surrounding the core, the at least one cladding layer comprising a second relative refractive index 42 smaller than the first relative refractive index Δ₁ of the at least one core;
wherein the step-index MMF comprises a spin profile that varies according to a spin function, wherein the spin profile comprises at least one spin period of greater than or equal to 1 meters to less than or equal to 20 meters and at least one spin amplitude greater than zero turns per meter and less than or equal to 10 turns per meter.

2. The step-index MMF according to claim 1, wherein the spin function is an Amplitude Modulation (AM) spin function or a Frequency Modulation (FM) spin function, or a combination of both.

3. The step-index MMF according to claim 2, wherein the spin function is an AM spin function, wherein the AM spin function is defined as:
$$a = [ {α}_{0} sin ( 2 π z / {Λ}_{m} ) ] sin ( 2 π z / Λ )$$
wherein α₀ is the spin amplitude and is greater than 0 turns/meter to less than or equal to 10 turns/meter, Λₘ is the spin period in units of meters, wherein Λₘ is in the range of greater than 1 to less than or equal to 10 m, Λ is the mode spacing in meters between propagating modes, wherein Λ is in the range of 1 to 20 m.

4. The step index MMF according to claim 2, wherein the spin function is a FM spin function, wherein the FM spin function is defined as:
$$a = {α}_{0} sin \{ 2 π [ {f}_{0} + {f}_{m} sin ( \frac{2 π z}{Λ} ) ] \} ,$$
wherein the spin amplitude is do and is greater than zero and less than or equal to 10 turns/m, f₀ is a center frequency and ranges from greater than or equal to 1 to less than or equal to 10 m⁻¹, fₘ is a modulation frequency that ranges from 1 to 20 m⁻¹, Λ is the spin period and ranges from 1 to 10 m.

5. The step-index MMF according to claim 1, wherein the spin function is based on a sinusoidal spin function, wherein the sinusoidal spin function is defined as:
$$a ( z ) = {α}_{0} cos ( η z )$$
where a₀ is the spin amplitude, z is the length of the fiber in meters and η is an angular frequency of spatial modulations, which is linked to the spin period Λ in the form of η=2π/Λ.

6. The step-index MMF according to claim 1, wherein the at least one spin period is greater than 3 and less than 10 m and the at least one spin amplitude is greater than 1 and less than or equal to 5 turns per meter.

7. The step-index MMF according to claim 1, wherein the radius r is greater than 6 μm and less than 25 μm.

8. The step-index MMF according to claim 1, wherein Δ₁−Δ₂ is greater than or equal to 0.075% and less than or equal to 2%.

9. The step-index MMF according to claim 1, wherein the core comprises a central elevated portion comprising the first relative refractive index Δ₁ and a remaining portion comprising a third relative refractive index Δ₃ that is less than Δ₁ by greater than or equal to 0.1%

10. The step-index MMF according to claim 9 wherein the central elevated portion comprises a radius Rₛ and the remaining portion extends radially from Rₛ to a core radius R_{c}, wherein R_{c}/Rₛ is greater than or equal to 2 and less than or equal to 4.

11. A mode division multiplexing system comprising a step-index multimode optical fiber (MMF), comprising:
a transmitter system comprising:
a linear array of sources configured to emit a plurality of optical signals that form a linear source signal in combination with one another; and a mode multiplexer comprising a first phase plate configured to apply a varying phase to the plurality of optical signals to convert the linear source signal into an annular source signal; and a first optical element configured to focus the annular source signal into a first light cone; an optical link comprising a step-index MMF,
wherein the step-index MMF comprises:
at least one core with a central axis, a first relative refractive index Δ₁, a radius r, and a diameter d extending through the central axis;
at least one cladding layer surrounding the core, the at least one cladding with a second relative refractive index Δ₂, wherein Δ₂ is less than Δ₁ of the at least one core; and
a spin profile that varies along a length of the step-index MMF according to a spin function, wherein the spin profile comprises at least one spin period of greater than or equal to 1 meters to less than or equal to 20 meters and at least one spin amplitude greater than zero turns per meter and less than or equal to 10 turns per meter,
wherein the step-index MMF is positioned with respect to the optical element such that the first light cone enters the optical fiber at an entrance angle θᵢ associated with a modal group of the step-index MMF such that the plurality of optical signals excite a plurality of spatial modes within the modal group and exit the step-index MMF as a second light cone; and
a receiver system comprising:
a second optical element configured to convert the second light cone into an annular receiving signal, wherein the step-index MMF reduces temporal spacing between spatial modes within the modal group of the second light cone so that the spatial modes of the modal group arrive simultaneously at the second optical element;
a mode demultiplexer comprising a second phase plate configured to apply a varying phase to the annular receiving signal to convert the optical signals exciting each of the plurality of spatial modes to a segment of linear receiving signal; and
an array of receiving elements configured to independently receive one of the segments.

12. The mode division multiplexing system according to claim 11, wherein the at least one core comprises a diameter that is less than or equal to 25 μm.

13. The mode division multiplexing system according to claim 11, wherein Δ₁−Δ₂ is greater than or equal to 0.075% and less than or equal to 2%.

14. The mode division multiplexing system according to claim 11, wherein the plurality of optical signals are a plurality of coherent optical signals at a single source wavelength λs.

15. The mode division multiplexing system according to claim 11, wherein:
the transmitter system comprises a plurality of linear arrays of sources,
the first phase plate is configured to apply a different varying phase to linear source signals emitted by each of the plurality of linear arrays of sources to convert the linear source signals into a plurality of annular source signals,
the first optical element converts each of the plurality of annular source signals into a separate light cone such that each light cone enters the step-index optical fiber at an entrance angle θᵢ associated with a separate modal group of the step-index optical fiber.

16. The mode division multiplexing system according to claim 15, wherein each of the linear arrays of sources comprises a different length, each length being proportional to the modal group number excited by that linear array of sources.

17. The mode division multiplexing system according to claim 11, wherein the optical signals propagate down at least 3 mode groups of the step-index optical fiber.

18. The mode division multiplexing system according to claim 15, wherein the linear array of sources comprises at least four distinct optical signals such that at least four distinct spatial modes of the modal group are excited by within the modal group.

19. The mode division multiplexing system according to claim 13, wherein:
the second phase plate is disposed in a plane P1 extending in a direction perpendicular to a waveguide axis of the step-index optical fiber at an exit face thereof,
points of peak signal amplitude of the annular receiving signal are contained in a ring having coordinates (x₁, y₁) in the plane P1 after being focused by a conditioning optical element onto the plane P1, and
the annularly varying phase ϕ(x₁, y₁) applied by the second phase plate is expressed as
$$ϕ ( {x}_{1} , {y}_{1} ) = \frac{2 π {x}_{o}}{λ f} [ {x}_{1} ln ( \frac{{( {x}_{1}^{2} + {x}_{2}^{2} )}^{\frac{1}{2}}}{{R}_{o}} ) - {y}_{1} {tan}^{- 1} ( \frac{{y}_{1}}{{x}_{1}} ) - {x}_{1} ]$$
where Rₒ is a normalization radius, f is the focal length of the conditioning optical element and xₒ is a parameter selected to determine the length and the positioning of the linear receiving signal.

20. The mode division multiplexing system according to claim 11, wherein the core comprises a central elevated portion comprising the first relative refractive index Δ₁ and a remaining portion comprising a third relative refractive index Δ₃ that is less than Δ₁ by greater than or equal to 0.1%.

21. The mode division multiplexing system according to claim 20, wherein the central elevated portion comprises a radius Rₛ and the remaining portion extends radially from Rₛ to a core radius R_{c}, wherein R_{c}/Rₛ is greater than or equal to 2 and less than or equal to 4.

22. A method of transmitting optical signals from a transmitter system to a receiver system using a spun step-index multimode optical fiber (MMF), comprising:
at the transmitter system, converting a linear source signal output by a linear array of sources into an annular source signal, the linear source signal comprising a plurality of optical signals;
focusing the annular source signal as an input cone into a core of a spun step-index multimode optical fiber such that the input cone enters the core at an incidence angle associated with a modal group of the spun step-index optical fiber and each spatial mode of the modal group is occupied by one of the plurality of optical signals;
transmitting the optical signals in the spun step-index optical fiber such that optical signals exit the step-index optical fiber as an output cone; and
performing at the receiver system mode division demultiplexing of the optical signals by converting each spatial mode into a segment of a linear receiving signal and detecting the linear receiving signal via a linear array of receivers,
wherein the spun step-index MMF comprises:
at least one core with a central axis, a first relative refractive index Δ₁, a radius r, and a diameter d extending through the central axis;
at least one cladding layer surrounding the core, the at least one cladding with a second relative refractive index Δ₂, wherein Δ₂ is less than Δ₁ of the at least one core; and
a spin profile that varies along a length of the spun step-index MMF according to a spin function, wherein the spin profile comprises at least one spin period of greater than or equal to 1 meters to less than or equal to 20 meters and at least one spin amplitude greater than zero turns per meter and less than or equal to 10 turns per meter.

23. The method of claim 21, wherein:
the transmitter system comprises a plurality of linear arrays of sources outputting a plurality of linear source signals,
the converting comprises applying a different varying phase to each of the plurality of linear source signals to convert the plurality of linear source signals into a plurality of annular source signals, and
focusing comprises converting each of the plurality of annular source signals into a separate light cone such that each light cone enters the step-index optical fiber at an entrance angle associated with a separate modal group of the step-index optical fiber.

24. The method of claim 22, wherein the optical signals propagate down at least 3 mode groups of the spun step-index multimode optical fiber, wherein the at least 3 mode groups have reduced temporal spacing of spatial modes within each mode group of the optical signals, wherein the optical signals and corresponding modal groups exit as light cones from the step index multimode optical fiber simultaneously.
